(19) United States
(12) Patent Application Publication
(10) Pub. No.: US 2008/0094567 A1
(43) Pub. Date: Apr. 24, 2008

(54) MULTI-PURPOSE EYEGLASSES

(75) Inventor: Woon-Taek Choi, Masan (KR)

Correspondence Address: MILES & STOCKBRIDGE PC, 1751 PINNACLE DRIVE, SUITE 500, MCLEAN, VA, 22102-3833, US

(73) Assignee: KBC America, Inc., Burbank, CA (US)

(21) Appl. No.: 11/573,808

(22) PCT Filed: Oct. 21, 2004
(86) PCT No.: PCT/US04/34628

§ 371 Date: Feb. 16, 2007

(30) Foreign Application Priority Data
Aug. 16, 2004 (KR) 20 2004 0023362

(51) Int. Cl. G02C 9/00

(52) U.S. Cl. 351/57

(57) ABSTRACT

A pair of multi-purpose eyeglasses has a main frame (10) and an inner frame (20). The main frame (10) includes a lens holder for holding lenses and a pair of temple arms (14) foldably connected to both ends of the lens holder. The main frame has a pair of side assembling grooves formed on opposite edge portion of a rear surface of the lens holder. Each of the side assembling grooves (16) extending in a vertical direction and having an open upper and a closed lower end. The inner frame is detachably assembled with a rear surface of the lens holder and has a pair of side assembling protrusions (22) which are inserted in and engaged with the side assembling grooves when the inner frame is assembled with the main frame.

### BACKGROUND OF THE INVENTION

1. Field of the Invention

The present invention relates to a pair of multi-purpose eyeglasses, and more particularly to a pair of eyeglasses which include can prevent wind or foreign substances from coming into eyes of a wearer, thereby enabling the wearer to use the eyeglasses in various purposes, e.g. to enjoy active or contact sports while wearing the eyeglasses.

2. Description of the Prior Art

It is typical that each pair of eyeglasses has a specific use. For example, eyeglasses may be used for preventing a wearer's eyes from being dazzled by sunlight or for compensating for a poor eyesight. However, Korean Utility Model registration No. 20-0315941 discloses a pair of multi-purpose eyeglasses, which not only can be used as general-purpose eyeglasses or sunglasses but also can protect eyes of a wearer riding on a high-speed vehicle such as a -motorcycle by preventing foreign substances from coming into eyes of the wearer.

The disclosed eyeglasses include an inner frame to be in close contact with the skin around the eyes, thereby preventing wind or foreign substances from coming into eyes of a wearer.

However, the inner frame of the disclosed eyeglasses has a relatively complicated structure, which increases the manufacturing cost of the eyeglasses and causes it difficult for a user to assemble or handle the eyeglasses.

Further, the disclosed eyeglasses have a sponge portion which is attached to an inner side of the inner frame and is in close contact with the skin around a wearer's eyes. However, the sponge portion may become detached from the inner side of the inner frame or easily worn out, thus losing its original function after it comes into contact with the skin around a wearer's eyes many times over a long period.

### SUMMARY OF THE INVENTION

Accordingly, the present invention has been made to solve the above-mentioned problems occurring in the prior art, and an object of the present invention is to provide a pair of multi-purpose eyeglasses, which can be handled more simply and easily by a user and is durable and reliable despite use over an extended period of time.

In order to accomplish this object, there is provided a pair of multi-purpose eyeglasses comprising: a main frame including a lens holder for holding lenses and a pair of temple arms foldably connected to both ends of the lens holder, the main frame having a pair of side assembling grooves formed on opposite edge portions of a rear surface of the lens holder, each of the side assembling grooves extending in a vertical direction and having an open upper and a closed lower end; an inner frame detachably assembled with a rear surface of the lens holder, the inner frame having a pair of side assembling protrusions which are inserted in and engaged with the side assembling grooves when the inner frame is assembled with the main frame; and a sealing member including a sponge portion attached to a rear surface of the inner frame and a leather portion attached to a rear surface of the sponge portion.

It is preferred that each of the side assembling grooves and the side assembling protrusions has a dovetail shape in its cross-sectional view.

It is also preferred that a central assembling groove is formed at a middle portion of the rear surface of the lens holder and a central assembling protrusion is formed at a middle portion of the front surface of the inner frame and extends in a horizontal direction, each of the central assembling groove and the central assembling protrusion extending in a horizontal direction.

### BRIEF DESCRIPTION OF THE DRAWINGS

The above and other objects, features and advantages of the present invention will be more apparent from the following detailed description taken in conjunction with the accompanying drawings, in which:

FIG. 1 is an exploded perspective view of a pair of multi-purpose eyeglasses according to an embodiment of the present invention; and

FIG. 2 is a partial exploded perspective view of a pair of multi-purpose eyeglasses shown in FIG. 1.

### DETAILED DESCRIPTION OF THE PREFERRED EMBODIMENTS

Hereinafter, a preferred embodiment of the present invention will be described with reference to the accompanying drawings.

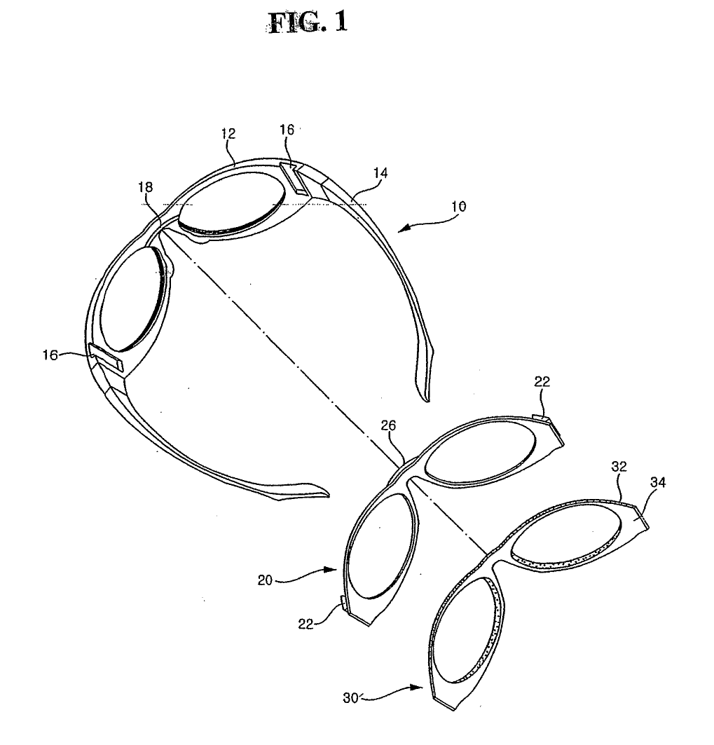

FIG. 1 is an exploded perspective view of a pair of multi-purpose eyeglasses according to an embodiment of the present invention.

As shown, the multi-purpose eyeglasses according to the embodiment of the present invention include a main frame 10, an inner frame 20 detachably assembled with a rear surface of the main frame 10, and a sealing member 30 attached to a rear surface of the inner frame 20.

The main frame 10 includes a lens holder 12 for holding a pair of lenses and a pair of temple arms 14 connected to both ends of the lens holder 12. As shown, it can be said that the general shape and construction of the main frame 10 are nearly identical to those of a pair of typical eyeglasses or sunglasses.

A pair of side assembling grooves 16 are formed on opposite edge portions of a rear surface of the lens holder 12. Each of the side assembling grooves 16 extends in a vertical direction and has an open upper and a closed lower end. It is needless to say that each of the side assembling grooves 16 formed on the rear surface of the lens holder 12 has an open rear side. The side assembling grooves 16 are used in assembling the main frame 10 and the inner frame 20 with each other, which will be described later in more detail.

The inner frame 20 is assembled with the rear surface of the lens holder 12. The inner frame 20 has nearly the same shape as that of the lens holder 12 and can be detachably assembled with the rear surface of the lens holder 12. Specifically, it is preferred that the front surface of the inner frame 20 and the rear surface of the lens holder 12 have the same shape so that the inner frame 20 can be tightly assembled with the rear surface of the lens holder 12.

A pair of side assembling protrusions 22 are formed on opposite edge portions of a front surface of the inner frame 20. The side assembling protrusions 22 are engaged with the side assembling grooves 16, thereby enabling the lens holder 12 and the inner frame 20 to be tightly assembled with each other and preventing them from becoming separated from each other. Further, as noted from the shown embodiment, each of the side assembling grooves 16 and the side assembling protrusions 22 extends in a vertical direction. However, it goes without saying that the side assembling grooves 16 and the side assembling protrusions 22 may have various modified shapes or constructions on condition that the side assembling grooves 16 and the side assembling protrusions 22 should enable the inner frame 20 to be assembled with the rear surface of the lens holder 12 and supported by the lens holder 12 without being separated.

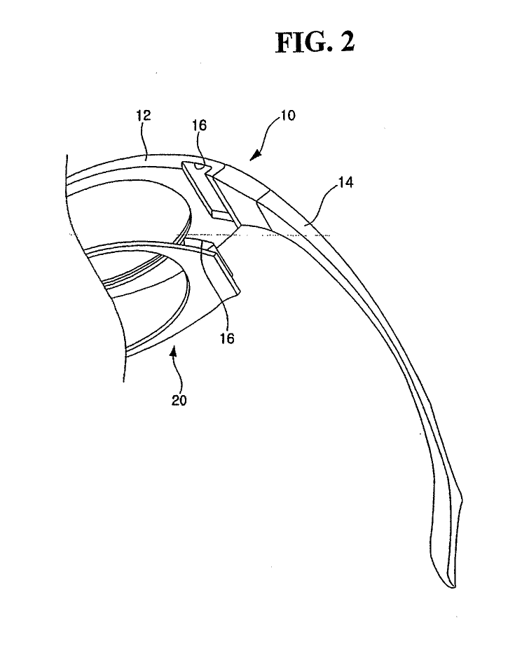

FIG. 2 shows the side assembling grooves 16 and the side assembling protrusions 22 in more detail. Each of the side assembling grooves 16 and the side assembling protrusions 22 has a dovetail shape in its cross-sectional view. That is, the side assembling grooves 16 are dovetail grooves and the side assembling protrusions 22 are dovetail protrusions. In other words, each of the side assembling grooves 16 has a bottom having a width larger than that of its rear side opening and each of the side assembling protrusions 22 has a neck having a width smaller than that of its apex. Therefore, the side assembling protrusions 22 and the side assembling grooves 16 can be engaged with each other by inserting the side assembling protrusions 22 downward from the open upper ends of the side assembling grooves 16 into the side assembling grooves 16. The engagement between the side assembling protrusions 22 and the side assembling grooves 16 each having the dovetail shape ensures the lens holder 12 and the inner frame 20 to be tightly assembled with each other and prevents them from being separated from each other.

The sealing member 30 having nearly the same shape as that of the inner frame 20 is attached to the inner side (rear side) of the inner frame 20. The sealing member 30 comes into close contact with the skin around a wearer's eyes when the wearer has put on the eyeglasses, thereby preventing foreign substances from coming into eyes of a wearer. The sealing member 30 includes a sponge portion 32 and a leather portion 34. The sponge portion 32 is made of sponge and attached to the inner side of the inner frame 20, and the leather portion 34 is made of leather and attached to the inner side of the sponge portion 32. The sponge portion 32 has elasticity, which enables the sealing member 30 inside of the inner frame 20 to come into sufficiently close contact with portions around eyes of a wearer of the eyeglasses.

Further, the leather portion 34 is an element most frequently contacting the face of a wearer and preventing the sponge portion 32 from being worn out or damaged through repetitive contact. Therefore, the leather portion 34 is formed of leather having a sufficient resistance to wear due to repetitive contact, including both artificial leather and natural leather. Otherwise, the leather portion 34 may be formed of other materials showing a good wear-proofness and having an affinity for a human body. The leather portion 34 prevents waste materials on a surface of a wearer's skin from coming into the sponge portion 32, thereby preventing germs from propagating in the sponge portion 32.

Further, it is preferred that the sealing member 30 is subjected to a separate heat treatment so that the sealing member 30 can have a shape-memory capability and the outer surface of the sealing member 30 can maintain the same shape as that of the inner surface of the sealing member 30. As a result, the sealing member 30 attached to the rear surface of the inner frame 20 can restore its shape even after being deformed and come into tight contact with parts around a wearer's eyes.

The eyeglasses having the construction described above in which the inner frame 20 having the sealing member 30 attached thereto is fitly assembled with the inside of the main frame 10 can come into tight contact with parts around a wearer's eyes when the eyeglasses are put on by the wearer. Therefore, the wearer of the eyeglasses can enjoy riding a motorcycle or playing other sports in comfort and safety.

A central assembling groove 18 is formed at a middle portion of the rear surface of the lens holder 12 of the main frame 10 and extends in a horizontal direction. Further, a central assembling protrusion 26 is formed at a middle portion of the front surface of the inner frame 20 and extends in a horizontal direction. When the inner frame 20 is assembled with the rear surface of the lens holder 12, the central assembling protrusion 26 is inserted in and engaged with the central assembling groove 18, thereby enhancing the assembly between the inner frame 20 and the lens holder 12.

In the eyeglasses according to the present invention, when the inner frame 20 is assembled with the lens holder 12, the side assembling protrusions 22 are inserted downward into the side assembling grooves 16 from the open upper end of the side assembling grooves 16. When the side assembling protrusions 22 have been completely inserted in the side assembling grooves 16, the engagement between the side assembling protrusions 22 and the side assembling grooves 16 each having the dovetail shape enables the inner frame 20 to be tightly assembled with the rear surface of the lens holder 12. Also, in eyeglasses according to the present invention, the inner frame 20 can be detachably assembled with the rear surface of the main frame 10 by the user's simple operation.

The eyeglasses according to the present invention are advantageous in the following points.

First, a simple construction employed in the eyeglasses enables the inner frame to be detachably assembled with the rear surface of the main frame of the eyeglasses, thereby reducing the manufacturing cost of the eyeglasses and providing enhanced convenience for a user of the eyeglasses.

Second, the sealing member employed in the eyeglasses enables the eyeglasses to be in close contact with the surrounding skin of the wearer's eyes, to be used for long time, and to be kept clean and sanitary.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A pair of multi-purpose eyeglasses comprising:
a main frame including a lens holder for holding lenses and a pair of temple arms foldably connected to both ends of the lens holder, the main frame having a pair of side assembling grooves formed on opposite edge portions of a rear surface of the lens holder, each of the side assembling grooves extending in a vertical direction and having an open upper and a closed lower end;
an inner frame detachably assembled with a rear surface of the lens holder, the inner frame having a pair of side assembling protrusions which are inserted in and engaged with the side assembling grooves when the inner frame is assembled with the main frame; and
a sealing member including a sponge portion attached to a rear surface of the inner frame and a leather portion attached to a rear surface of the sponge portion.

2. A pair of multi-purpose eyeglasses as claimed in claim 1, wherein each of the side assembling grooves and the side assembling protrusions has a dovetail shape in its cross-sectional view.

3. A pair of multi-purpose eyeglasses as claimed in claim 1, wherein a central assembling groove is formed at a middle portion of the rear surface of the lens holder and a central assembling protrusion is formed at a middle portion of the front surface of the inner frame and extends in a horizontal direction, each of the central assembling groove and the central assembling protrusion extending in a horizontal direction.
